(19) United States
(12) Patent Application Publication
(10) Pub. No.: US 2004/0256807 A1
(43) Pub. Date: Dec. 23, 2004

(54) Retrofittable non-metallic brush seal assembly

(76) Inventors: Nitin Bhate, Clifton Park, NY (US); Mahmut Faruk Aksit, Istanbul (TR); Mehmet Demiroglu, Troy, NY (US); Anthony Constantine Thermos, Greer, SC (US)

Correspondence Address: GENERAL ELECTRIC COMPANY (PCPI), C/O FLETCHER YODER, P. O. BOX 692289, HOUSTON, TX, 77269-2289, US

(21) Appl. No.: 10/601,109

(22) Filed: Jun. 23, 2003

(51) Int. Cl. F16J 15/44

(52) U.S. Cl. 277/355

(57) ABSTRACT

A bearing assembly for supporting a rotating component of a rotary machine includes a bearing housing and a metallic clearance seal attached to the bearing housing. The metallic clearance seal having at least one tooth is configured to extend radially outward from the bearing housing spaced apart from the rotating component to define an envelope having a pre-determined cross-sectional shape. A non-metallic brush seal assembly is fixedly attached to the metallic clearance seal having a second pre-determined cross-sectional shape. The non-metallic brush seal assembly is adapted to the metallic clearance seal to extend through the envelope and terminate in substantially intimate contact with the rotating component. The non-metallic brush seal assembly comprises a plurality of fibers to substantially arrest leakage of a lubricant from the bearing housing to the envelope.

### BACKGROUND OF INVENTION

The present invention relates to sealing systems for bearings of rotating machines and more particularly to retrofittable non-metallic brush seals for such sealing systems.

Rotating machinery for example, gas turbines and steam turbines generally include rotating components such as a shaft, typically supported by at least a pair of oil-lubricated bearings attached to a stationary component. Leakage of lubricating oil mist radially outwards from a bearing cavity to other adjacent components, for example, compressor of the gas turbine, is generally undesirable because the hot thermal environment of these components may cause coking of the oil mist forming carbonized solid particles. In certain circumstances, these carbonized particles may undesirably foul the rotating machine components resulting degradation of performance of these rotating machines. Additionally, these carbonized particles may sometimes cause damage to the rotating machine components.

In some conventional sealing systems, metallic clearance seals that have a plurality of axially spaced seal teeth are installed between the shaft and the bearing housing of the rotating machines to arrest undesirable oil leakage from the bearing cavity to its adjacent components. Sealing effectiveness of these metallic clearance seals depends on maintaining a desired “seal clearance” between the sealing system and the shaft. In implementation, this “seal clearance” often needs to be maintained at a value larger than the “desired seal clearance” in order to avoid potential interference of these metallic clearance seals with radial excursions of the shaft. As a consequence, oil from the bearing cavity undesirably leaks through the enlarged “seal clearance” degrading the sealing effectiveness further.

In some other conventional practices, metallic clearance seals installed in existing sealing systems of the bearing assembly are entirely replaced with non-metallic brush seals. Implementing such practice generally includes a series of activities, for example, dismantling the rotating components from the stationary components, uninstalling the entire metallic clearance seal assembly from the bearing housing and installing the non-metallic brush seal assembly in a position previously occupied by the metallic clearance seal. In operation, those activities, unless performed carefully, bear potential risk of damaging the rotating components, such as the shaft. Moreover, these activities stretch overall downtime of the rotating machine degrading its availability further.

Accordingly, there is a need in the art to design an efficient sealing system having adaptability for quick and easy retrofitting to the existing sealing systems of the rotating machine in order to maximize availability thereof.

### BRIEF DESCRIPTION

The present technique is designed to address such needs. Briefly, in accordance with one embodiment of the present technique, a bearing assembly for supporting a rotating component of a rotary machine comprises a bearing housing and a metallic clearance seal attached to the bearing housing. The metallic clearance seal having at least one tooth is configured to extend radially outward from the bearing housing in a spaced apart relationship with the rotating component to define an envelope having a pre-determined cross-sectional shape. A non-metallic brush seal assembly is fixedly attached to the metallic clearance seal having a second pre-determined cross-sectional shape. The non-metallic brush seal assembly is adapted to the metallic clearance seal to extend through the envelope and terminate in substantially intimate contact with the rotating component. The non-metallic brush seal assembly comprises a plurality of fibers to substantially arrest leakage of a lubricant from the bearing housing to the envelope.

A method embodiment for retrofitting a non-metallic brush seal in a bearing assembly comprises the steps of accessing an existing metallic clearance seal having a plurality of teeth, the metallic clearance seal being attached to the bearing housing; machining at least one tooth of the existing metallic clearance seal to form an envelope having a pre-determined cross-sectional shape adapted to receive a non-metallic brush seal assembly, the non-metallic brush seal assembly being constructed of a plurality of fibers for substantially arresting leakage of a lubricant from the bearing housing to the envelope; assembling said non-metallic brush seal assembly in the envelope having the pre-determined cross-sectional shape; and securing the non-metallic brush seal assembly with the metallic clearance seal to prevent circumferential displacement of the non-metallic brush seal assembly relative to the metallic clearance seal.

### DRAWINGS

These and other features, aspects, and advantages of the present invention will become better understood when the following detailed description is read with reference to the accompanying drawings in which like characters represent like parts throughout the drawings, wherein:

FIG. 1 is a sectional view of general arrangement of an exemplary rotating machine;

FIG. 2 is a sectional view of a shaft and a bearing assembly of the rotating machine of FIG. 1;

FIG. 3 is a cross-sectional view of a sealing system of the bearing assembly of FIG. 2 showing its adaptability to retrofit a second seal assembly in accordance with one aspect of the present technique;

FIG. 4 is a perspective cross-sectional view of the second seal assembly in accordance with one aspect of the present technique;

FIG. 5 is an exploded perspective view showing retrofitting of the second seal assembly in the sealing system in accordance one aspect of the present technique;

FIG. 6 is a cross-sectional view of the sealing system of the bearing assembly retrofitted with the second seal assembly in accordance with one aspect of the present technique;

FIG. 7 is a cross-sectional view of the sealing system of the bearing assembly retrofitted with the second seal assembly in accordance with another aspect of the present technique;

FIG. 8 is a cross-sectional view of the sealing system of the bearing assembly retrofitted with the second seal assembly in accordance with another aspect of the present technique;

FIG. 9 is a cross-sectional view of the sealing system of the bearing assembly retrofitted with the second seal assembly in accordance with another aspect of the present technique;

FIG. 10 is a cross-sectional view of the sealing system of the bearing assembly retrofitted with the second seal assembly in accordance with another aspect of the present technique; and

FIG. 11 is diagrammatical view showing method of retrofitting the second seal assembly with the sealing system of the bearing assembly in accordance with one aspect of the present technique.

### DETAILED DESCRIPTION

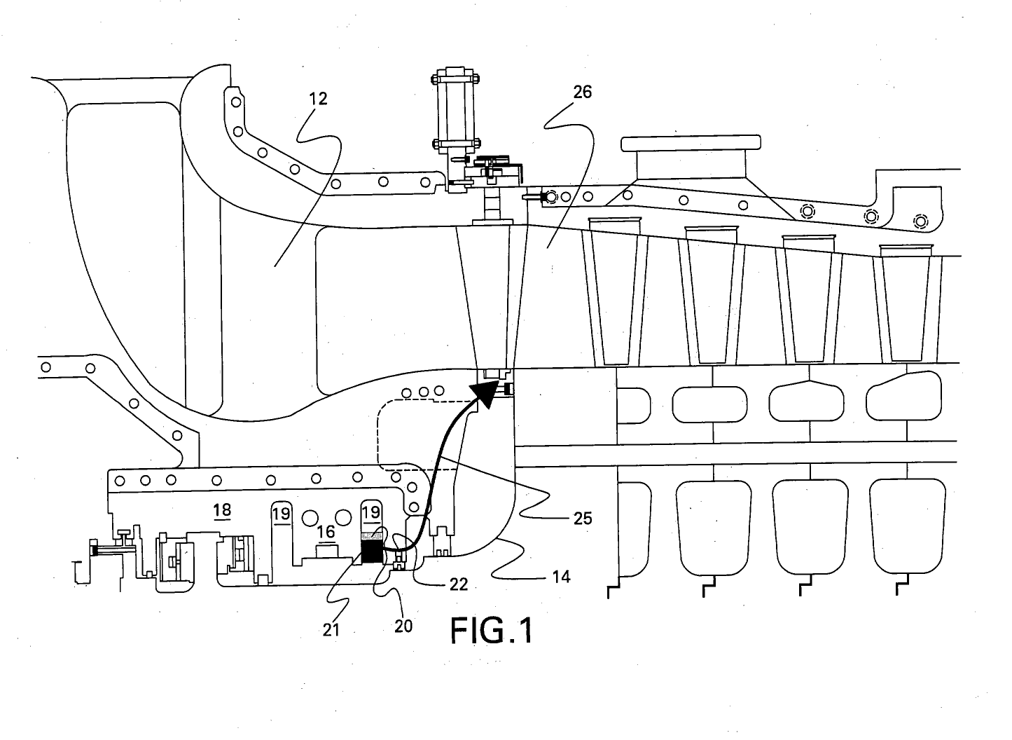

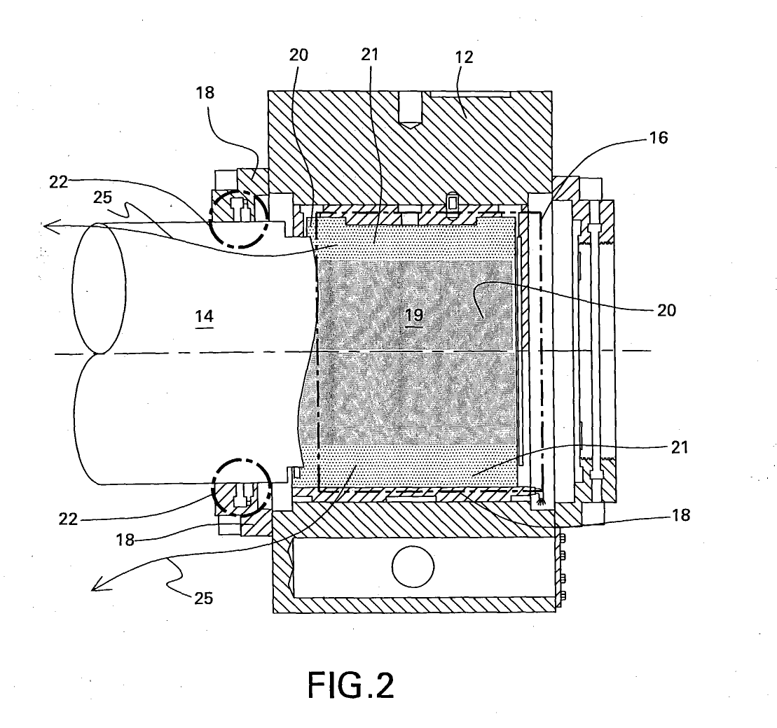

Rotating machinery for example, gas turbines 10 depicted in FIG. 1 typically include rotating components such as a shaft 14 that rotates relative to stationary components, for example, a casing 12. The shaft 14 is statically and dynamically supported by bearing assemblies 16 fixed with the stationary components 12 of the rotating machine 10. Referring to FIG. 1 and FIG. 2, each bearing assembly 16 includes a bearing housing 18 that defines a bearing cavity 19. The bearing cavity 19 contains lubricating oil 20 for hydrodynamic lubrication of the bearing assembly 16. Rotary movement of the shaft 14 inside the bearing cavity 19 causes hydrodynamic displacement of the lubricating oil 20 generating oil mists 21 therein. Typically, either due to absence or ineffectiveness of a sealing system 22 disposed between the shaft 14 and the bearing housing 18, such oil mists 21 undesirably leak from the bearing cavity 19 across a flow path 25 to reach its adjacent components, such as, for example a turbine compressor 26 of the gas turbine 10 (see FIG. 1). The hot thermal environment of these components causes burning of the oil mists 21 migrated therein to form carbonized solid particles. These carbonized particles may undesirably foul the rotating machine components, for example, the turbine compressor 26 and the shaft 14, resulting degradation of efficiency of these rotating machines. Additionally, these carbonized particles may sometimes cause damage to the rotating machine components.

In conventional practice, a sealing system 22 disposed between the shaft 14 and the bearing housing 18 includes a typical metallic clearance seal having a plurality of axially spaced teeth. Generally, a desired “seal clearance,” typically in the range from about 15 mils to about 19 mils, is maintained between the teeth and the shaft for effective functioning of these metallic clearance seals. Operationally, this “seal clearance” often needs to be maintained larger than the desired “seal clearance” in order to prevent certain undesirable events, for example, potential interference of the metallic clearance seal with radial excursions of the shaft. In such circumstances, the “seal clearance,” in operation, disadvantageously becomes large enough to permit migration of oil mist 21 from the bearing cavity 19 through the “enlarged seal clearance.” Furthermore, in the event of accidental damage to these metallic clearance seals constructing the sealing system 22, the “seal clearance” is enlarged further, resulting in additional degradation of the sealing effectiveness. It may be noted that, accidental damage of these metallic clearance seals may occur as a consequence of its potential interference with the shaft during transient and startup conditions of the rotating machine.

The “seal clearance” maintained between the teeth and the shaft of these metallic clearance seals define a flow path for receiving “sealing fluid,” typically air, that supplements sealing system 22 performance. Typically the “sealing fluid” maintains higher fluid pressure across the “seal clearance” compared to the fluid pressure in the bearing cavity 19 to enable arrest of oil leakage outwardly from the bearing cavity 19. The “sealing fluid” is delivered from another source, typically the compressor 26 driven by the rotating machine 10, for example, the gas turbine. Demand of such “sealing fluid” to supplement functioning of the sealing system 22 deteriorates overall power output of the rotating machine 10 as a consequence.

In some other practices, some of these metallic clearance seals installed in the sealing system 22 of the bearing assemblies are entirely replaced with non-metallic brush seals, particularly under circumstances when those metallic clearance seals are damaged. Operationally, replacing those metallic clearance seals with non-metallic brush seals includes a series of activities, for example, detachment and removal of the rotating components from the stationary components of the rotary machine, uninstalling the entire metallic clearance seal assembly from the bearing housing and installing the non-metallic brush seal assembly in a position previously occupied by those metallic clearance seals. It is a matter of valid concern that these activities, unless performed carefully, may potentially damage the rotating components, for example, the shaft. Moreover, those activities pertaining to replacement of these existing metallic clearance seals, increase the shutdown period of the rotating machine degrading its availability accordingly.

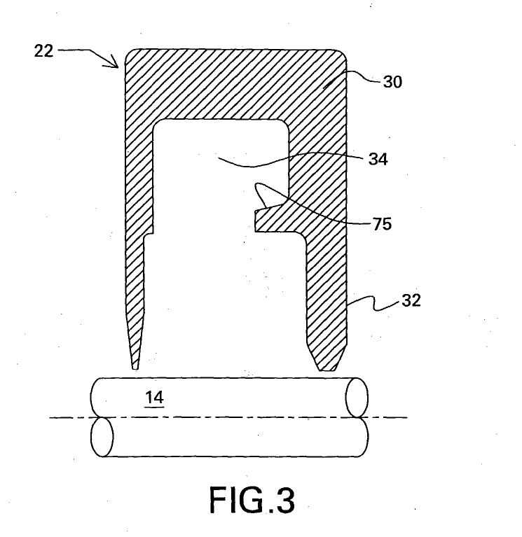

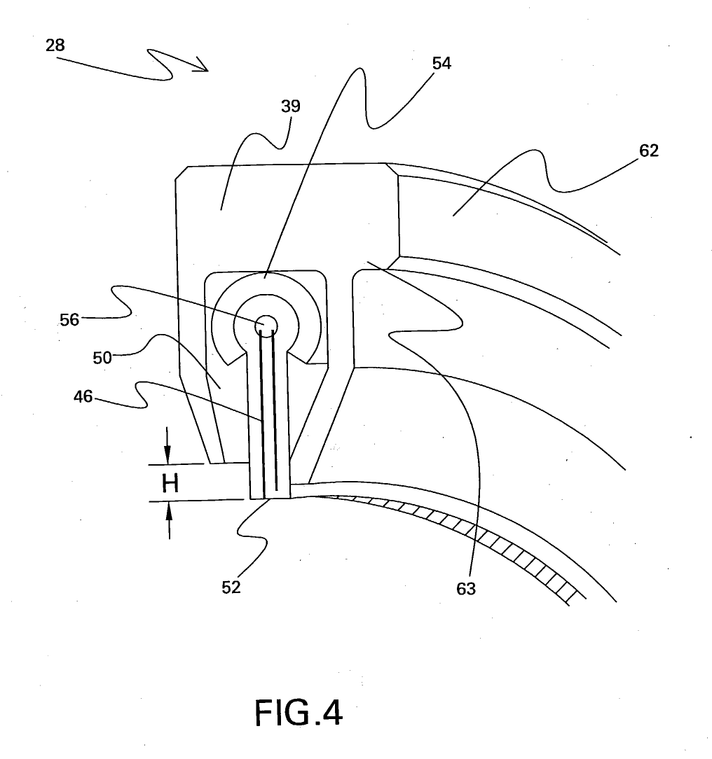

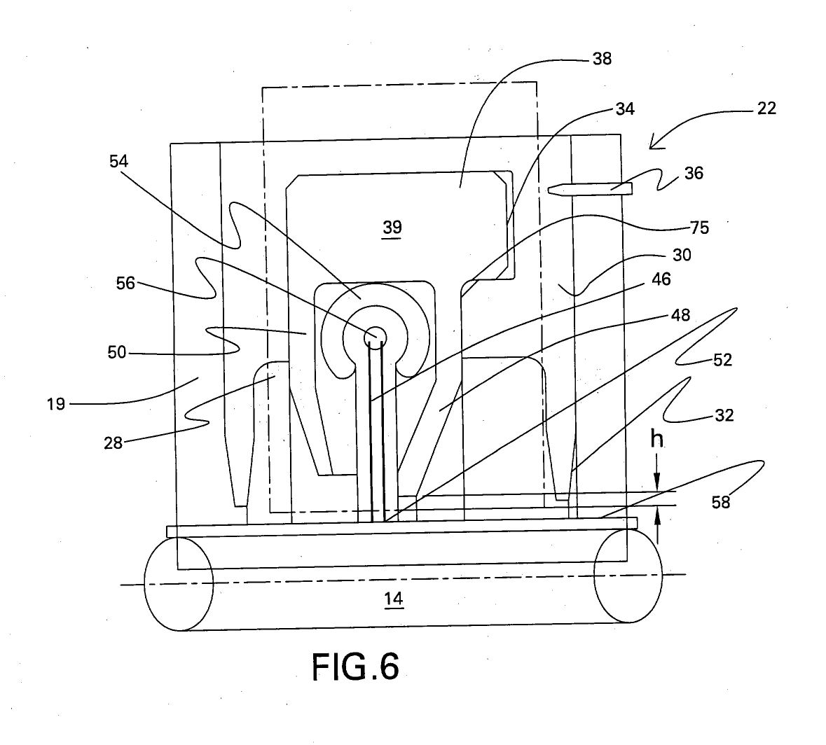

It will be apparent from discussion in subsequent paragraphs that the present technique can effectively address those abovementioned concerns. In accordance with one expression of the present technique depicted in FIG. 3, a metallic clearance seal 30 is configured to receive a typical non-metallic brush seal assembly 28 shown in FIG. 4. In operation, at least one tooth 32 of the metallic clearance seal 30 is machined, so that this metallic clearance seal 30 is spaced further apart from the shaft 14 to define an envelope 34 therebetween (removed tooth not shown). Such envelopes 34 have typical pre-determined cross-sectional shapes for adapting to corresponding non-metallic brush seal assembly 28 (see FIG. 6 through FIG. 10). More particularly, as may be apparent from FIG. 6 through FIG. 10, the non-metallic brush seals 28 conform to cross-sectional shapes of its corresponding matching envelopes to ensure their secured position in the sealing system 22. Typical anti-rotation pins 36 affixed to the metallic clearance seals 30 further secure position of the non-metallic brush seals 28 in the sealing system 22 by preventing its circumferential displacement relative to the metallic clearance seals 30 (see FIG. 6 for exemplary illustration).

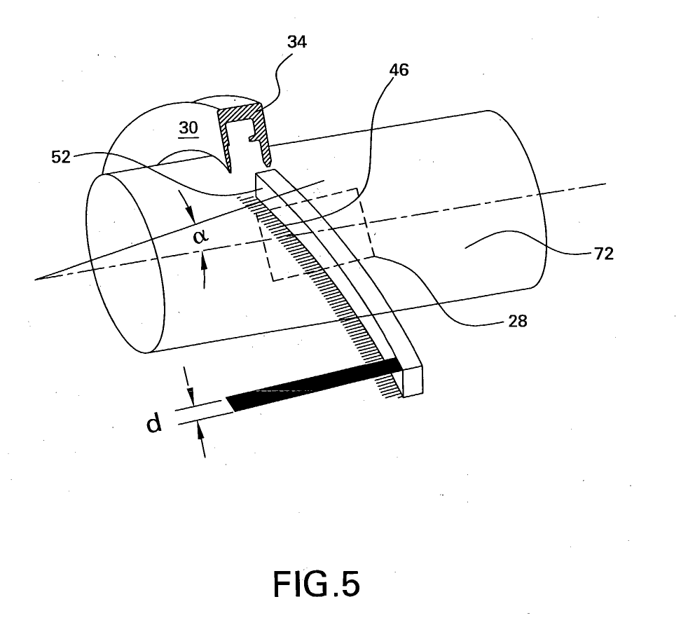

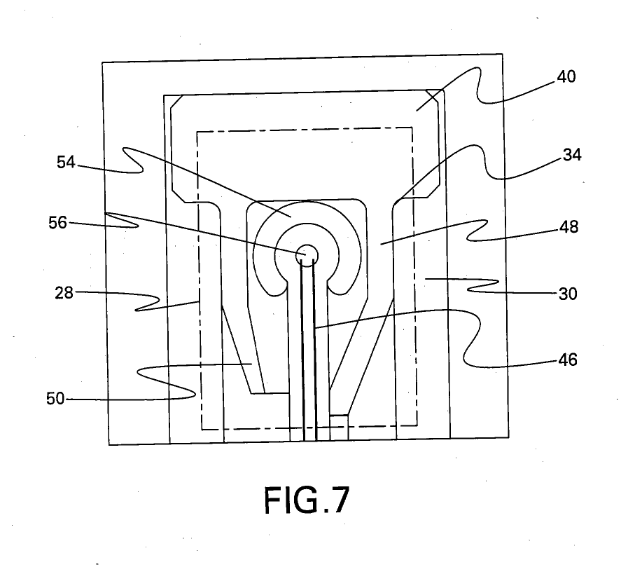

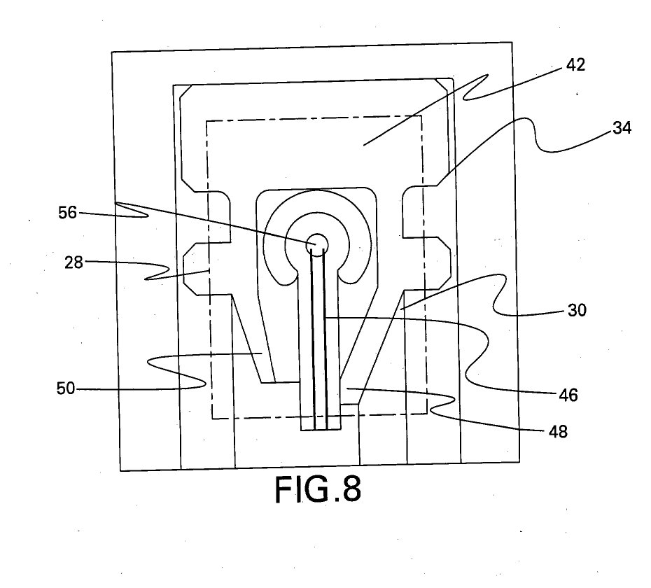

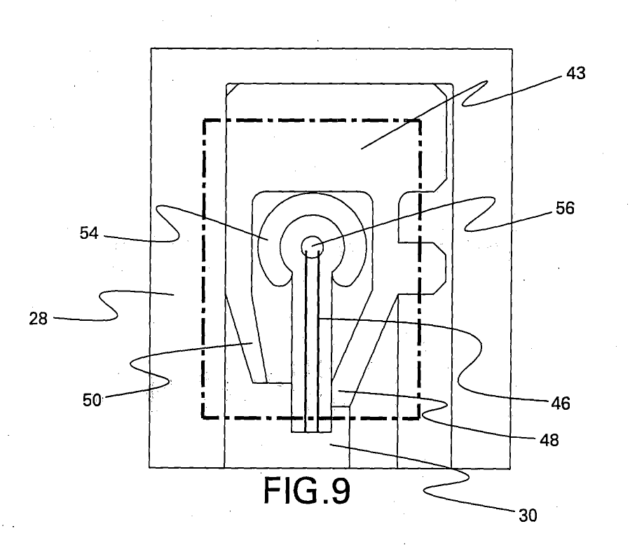

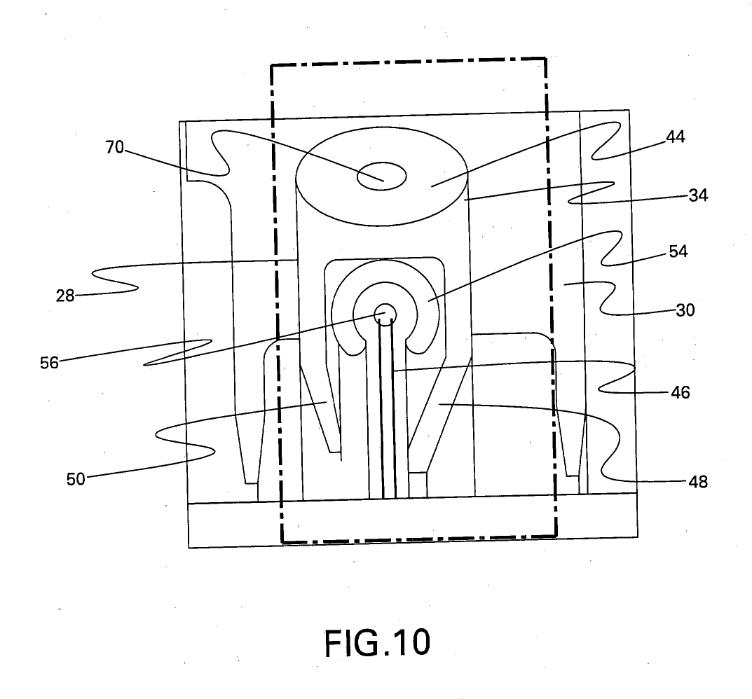

Different alternative cross-sectional shapes of the envelope 34 are envisioned depending on trade-off relationships among factors, such as, for example, ease of manufacturing the envelope 34 and corresponding non-metallic brush seal assembly 28 adapted therewith; ease of assembling the non-metallic brush seal 28 with the envelope 34 and secured positioning of the non-metallic brush seal 28 conforming to the envelope 34. Some exemplary embodiments pertaining to the cross-sectional shapes of the envelope 34 include, without limitation, an inverted L-shaped cross-section 38 (FIG. 6), a T-shaped cross-section 40 (FIG. 7), a H-shaped cross-section 42 (FIG. 8), a F-shaped cross-section 43 (FIG. 9) and an inverted U-shaped cross-section 44 (FIG. 10). According to one expression of the present technique, the envelope 38 has an inverted L-shaped cross-sectional geometry adapted to receive the non-metallic brush seal assembly 28 having matching cross-sectional configuration 39 (see FIG. 6). More particularly, an inner edge 63 of a radial surface 62 constructing the non-metallic brush seal 28 cross-section 39 conforms to its corresponding adapting surface 75 of the inverted L-shaped envelope 38 (see FIG. 4 and FIG. 6). Therefore, these non-metallic brush seals 28 can be securely positioned in the sealing system 22 maintaining concentricity with the metallic clearance seal 30. Furthermore, as shown in FIG. 5, such non-metallic brush seals 28 can be relatively easily assembled with the existing metallic clearance seals 30 by circumferentially sliding the brush seal assemblies 28 across the shaft 14 ensuring their relatively quick retrofittability in the sealing system 22.

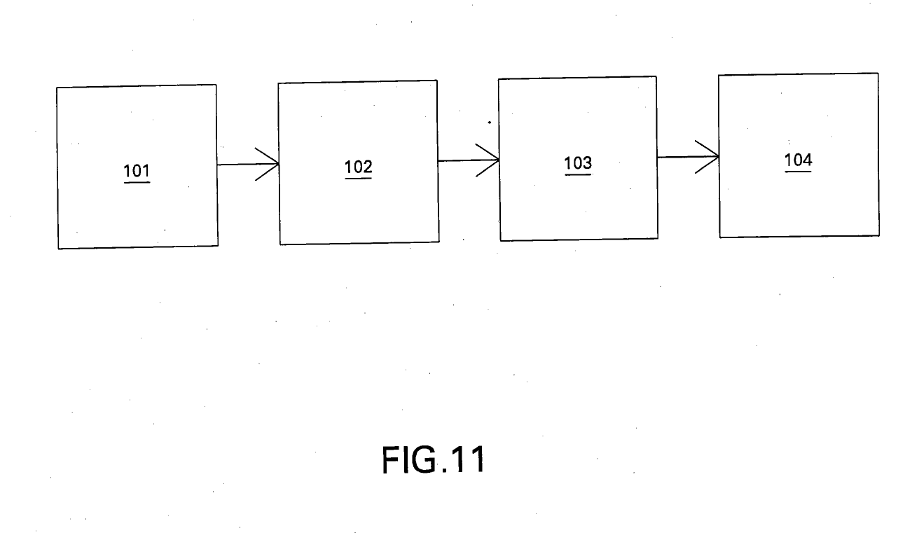

A method expression 100 for retrofitting a non-metallic brush seal 28 in a bearing assembly in accordance with the present technique is summarily depicted in FIG. 11. Operationally, this method expression includes a first step 101 of accessing an existing metallic clearance seal 30 having a plurality of teeth. Further, at a second step 102 of the method expression, at least one tooth of the existing metallic clearance seals 30 is machined to form an envelope 34 having a pre-determined cross-sectional shape. At a subsequent step 103, the non-metallic brush seal assembly 28 is assembled in the envelope 34. Final step 104 of the present method expression includes securing the non-metallic brush seal assembly 28 with the metallic clearance seal 30 to prevent circumferential displacement of the non-metallic brush seal assembly 28 relative to those metallic clearance seals 30. Such securing means typically include anti-rotation pins 36. The aspects describing various expressions of the non-metallic brush seal assembly 28 in accordance with this method expression are identical to those aspects discussed in subsequent paragraphs.

It is apparent from the above discussion that rertrofittable non-metallic brush seals 28 in accordance with the present technique are envisioned as “smart repair kits” for quickly repairing the sealing systems 22 when damaged. Operationally, certain undesirable events, for example, damage of at least one tooth of those existing metallic clearance seals 30 render the sealing systems 22 functionally ineffective. The present technique can effectively respond to those undesirable circumstances by adapting those damaged metallic clearance seals 30 to receive the non-metallic brush seals 28. Further, as discussed before, these non-metallic brush seals 28 can be assembled quickly in the sealing systems 22 without dismantling the rotating components from the stationary components of the rotating machine 10. Accordingly, quick retrofitting of these non-metallic brush seals 28 in the sealing systems 22 ensures minimum downtime of the rotating machine 10 on account of sealing system 22 repairs.

Typical constructional arrangement of these non-metallic brush seals 28 includes a plurality of non-metallic fibers 46 disposed between a pair of bristle holding plates 48, 50, for example, a front plate 48 and a back plate 50 (see FIG. 6 through FIG. 10). In some exemplary embodiments, the fibers 46 are typically heat welded (not shown) with the bristle holding plates 48, 50. In some other embodiments, the fibers 46 are folded around an annular wire 56 and further secured with the bristle holding plates 48, 50 by a retaining clamp 54. These non-metallic fibers 46 are constructed of filaments having materials including, without limitation, polymer fibers, carbon fibers, graphite fibers, ceramic fibers and combinations of these. Filament materials are generally chosen depending on trade-off relationships among their properties, such as, stiffness, creep resistance against temperature range typically from about 40° C. to about 250° C., wear resistance and chemical inertness against oil, for example. According to one expression of the present technique, polymer fibers of the non-metallic brush seal assembly 28 are constructed of KEVLAR® filaments (registered trademark of E. I. DuPont de Nemours and Company) for example.

The non-metallic fibers 46 of the brush seal assembly 28 are terminated in substantial intimate contact with the shaft 14 (see FIG. 6). As used herein, the term “substantial intimate contact” means engagement of distal end of the fibers (i.e. the fiber tips 52) with the shaft 14 without leaving significant clearance therebetween. Such “intimate contact” of fiber tips 52 with the shaft 14 advantageously enhances sealing effectiveness of the non-metallic brush seal assembly 28. Further, enhanced sealing effectiveness of these non-metallic brush seals 28 minimizes the requirement of “sealing air” delivered typically from the compressor 26 of the rotating machine 10, for example, the gas turbine, improving overall efficiency of those rotating machines 10.

Further, these non-metallic fibers 46 are typically “canted” at a pre-determined laying angle “α” with respect to radial direction (see FIG. 5). These “canted” non-metallic fiber tips 52 are radially deflected during their dynamic engagement with the shaft 14 (i.e. when the shaft 14 rotates in a desired direction) without loosing contact therebetween. Such radial deflection of these fibers 46 (depicted exaggeratedly in FIG. 5) advantageously ensures their “gentle ride” over the shaft 14 surfaces 72 to prevent structural deformation of these fibers 46. Typically, in some embodiments of the present technique, each of these non-metallic fibers 46 has laying angle “α” in the range from about 0° to about 45° and more particularly in the range from about 20° to about 40°. As may be appreciated that, choice of the laying angle “α” depends on trade-off relationship between factors such as, for example, structural stability of these fibers 46 and ease of assembling them with the bristle holding plates 48, 50.

These non-metallic fibers 46 sandwiched between the bristle holding plates 48, 50 are packed dense enough to arrest oil leakage through the gap between adjacent fibers. Generally, these non-metallic fibers 46 packed between the bristle holding plates 48, 50 have higher packing density (defined as number of fibers per unit surface area of the seal assembly) compared to metallic fibers. Accordingly, the non-metallic brush seal assembly 28 can substantially arrest oil leakage outwardly from the bearing cavity 19, compared to other sealing system designs including metallic brush seal assemblies, for example. Particularly, in some aspects of the present technique, that leakage is arrested typically more than about 70%. It may be noted that, as a result of increasing the packing density of these fibers 46, more surface area of the fibers 46 is exposed for “frictional engagement” with the shaft 14. Such increased “frictional engagement” may generate adequate thermal energy for carbonizing the oil mist 21. As discussed before, those carbonized oil particles may undesirably foul the shaft 14 as well as other components of the rotating machine 10 degrading their performance. Hence, although increase of packing density generally enhances sealing effectiveness of the non-metallic brush seal assembly 28, exceeding the packing density beyond a pre-determined range may be undesirable to avoid significant increase of frictional force arising due to increased frictional contact between the fibers 46 and the shaft 14. In certain embodiments of the present technique, the packing density is in the range from about 1000 per square inch to about 300,000 per square inch and more particularly, in the range from about 150,000 per square inch to about 250,000 per square inch. Further, in some embodiments, a friction-resistant layer 58 is disposed on the shaft 14 in order to minimize friction force between the fibers 46 and the shaft 14 during their engagement. Such friction-resistant layer 58 comprises a self-lubricating material, for example, graphite.

These non-metallic fibers 46 should be desirably stable against aerodynamic load of pressurized working fluid flowing through a flow path defined by the sealing system 22 and the shaft 14. Therefore, diameter “d” (depicted exaggeratedly in FIG. 5) of those fibers 46 is chosen primarily to ensure its structural stability against the aerodynamic forces applied thereupon. Increasing diameter “d” value enhances corresponding stiffness of these fibers 46 at the expense of their compliance. Lack of adequate compliance of these fibers 46 result in “hard engagement” of those “relatively stiff” fiber tips 52 against the shaft 14. Such “hard engagement” may inadvertently cause severe indentation and scoring on the shaft 14. Further, it may be noted that compliance of these fibers 46 is a function of filament material. For example, polymer fibers constructed of KEVLAR® (registered trademark of E. I. DuPont de Nemours and Company) filaments are relatively better compliant compared to other filament materials. Therefore, designing diameter “d” of these fibers 46 constructed of a chosen filament material depends on trade-off between factors, such as, its structural stability and desired compliance thereof. In some embodiments of the present technique, the diameter “d” of each of these non-metallic fibers 46 is in the range from about 0.2 mils to about 6 mils and more particularly in the range from about 0.4 mils to about 1 mil. Further, desirable stiffness of these fibers 46, in certain embodiments of the present technique, is in the range from about 0.2 psi/mil to about 20 psi/mil and more particularly in the range from about 0.4 psi/mil to about 5 psi/mil, depending on choice of diameter “d” ranges and filament material of those fibers 46.

These fibers 46 are radially projected from the bristle holding plates 48, 50 through a desired “fence-height” “h” (see FIG. 4 and FIG. 6). In certain circumstances, for example during transient and startup conditions of the rotating machine 10 the average “fence-height” “h” needs to be maintained greater than its desired value to avoid damage of the shaft 14 during its potential interference with the bristle holding plates 48, 50. On the other hand, exceeding the “fence-height” “h” beyond its desired value exposes more surface area of the fibers 46 to the pressurized working fluid blowing through the flow path defined by the sealing system 22 and the shaft 14. Hence, the adjacent fibers 46 may be axially displaced from their reference position to define a gap therebetween. Such gap can undesirably allow room for oil leakage therethrough. Therefore, in order to maintain the desired “fence-height” “h” without compromising structural integrity of the shaft 14, those bristle holding plates 48, 50 in some embodiments, are fabricated from a sacrificial material, for example, polyester. The bristle holding plates 48, 50 in present embodiments, can be indented during its potential interference with the shaft 14 without causing damage thereof. In some embodiments of the present technique, the “fence-height” “h” is in the range from about 20 mils to about 100 mils and more particularly, in the range from about 30 mils to about 60 mils.

It is desirable to mention that, the present technique depicted in the drawings appended herewith shows only an exemplary location of the retrofitted sealing systems 22 with respect to the bearing housing 18. Further embodiments pertaining to positioning the sealing system 22 in various pre-determined locations within the bearing housing 18 may be envisaged depending on the local temperatures to which the sealing systems 22 are exposed at these locations.

It will be apparent to those skilled in the art that, although the invention has been illustrated and described herein in accordance with the patent statutes modification and changes may be made to the disclosed embodiments without departing from the true spirit and scope of the invention. It is, therefore, to be understood that the appended claims are intended to cover all such modifications and changes as fall within the true spirit and scope of the invention.

1. A bearing assembly for supporting a rotating component of a rotary machine comprising:
a bearing housing;
a metallic clearance seal having at least one tooth; said metallic clearance seal attached to said bearing housing is configured to extend radially outward from said bearing housing in a spaced apart relationship with said rotating component to define an envelope having a pre-determined cross-sectional shape; and
a non-metallic brush seal assembly fixedly attached to said metallic clearance seal having a second pre-determined cross-sectional shape; said non-metallic brush seal assembly adapted to said metallic clearance seal to extend through said envelope and terminate in substantially intimate contact with said rotating component;
wherein said non-metallic brush seal assembly comprises a plurality of fibers to substantially arrest leakage of a lubricant from said bearing housing to said envelope.

2. The bearing assembly in accordance with claim 1, wherein said non-metallic brush seal assembly further comprises at least a pair of bristle holding plates for securing said plurality of fibers.

3. The bearing assembly in accordance with claim 2, wherein said non-metallic brush seal assembly further comprises anti-rotation pins affixed to said metallic clearance seal to prevent circumferential displacement of the non-metallic brush seal assembly relative to the metallic clearance seal.

4. The bearing assembly in accordance with claim 1, wherein said metallic clearance seal comprises a labyrinth seal.

5. The bearing assembly in accordance with claim 1, wherein said pre-determined first cross-sectional shape comprises at least one of an inverted L-shaped cross section or inverted U-shaped cross-section or F-shaped cross-section or T-shaped cross-section or H-shaped cross-section.

6. The bearing assembly in accordance with claim 1, wherein said non-metallic fibers are selected from the group consisting of polymer fibers, carbon fibers, graphite fibers, ceramic fibers and combinations thereof.

7. The bearing assembly in accordance with claim 1, wherein each of said non-metallic fibers has diameter in the range from about 0.2 mils to about 6 mils.

8. The bearing assembly in accordance with claim 7, wherein each of said non-metallic fibers has diameter in the range from about 0.4 mils to about 1 mil.

9. The bearing assembly in accordance with claim 1, wherein each of said non-metallic fibers has stiffness in the range from about 0.2 psi/mil to about 20 psi/mil.

10. The bearing assembly in accordance with claim 9, wherein each of said non-metallic fibers has stiffness in the range from about 0.4 psi/mil to about 5 psi/mil.

11. The bearing assembly in accordance with, claim 1, wherein said plurality of non-metallic fibers have a packing density in the range from about 1000 per square inch to about 300,000 per square inch.

12. The bearing assembly in accordance with claim 11, wherein said plurality of non-metallic fibers have a packing density in the range from about 150,000 per square inch to about 250,000 per square inch

13. The bearing assembly in accordance with claim 1, wherein each of said non-metallic fibers has a laying angle in the range from about 0° to about 45°.

14. The bearing assembly in accordance with claim 13, wherein each of said non-metallic fibers has a laying angle in the range from about 20° to about 40°.

15. The bearing assembly in accordance with claim 1, wherein said plurality of non-metallic fibers has an average fence height in the range from about 20 mils to about 100 mils.

16. The bearing assembly in accordance with claim 15, wherein said plurality of non-metallic fibers has an average fence height in the range from about 30 mils to about 60 mils.

17. The bearing assembly in accordance with claim 1, wherein said rotating component has a friction-resistant layer disposed thereon.

18. The bearing assembly in accordance with claim 17, wherein said friction-resistant layer comprises a self-lubricating material.

19. A bearing assembly for supporting a rotating component of a rotary machine comprising:
a bearing housing;
a metallic clearance seal having at least one tooth; said metallic clearance seal attached to said bearing housing is configured to extend radially outward from said bearing housing in a spaced apart relationship with said rotating component to define an envelope having inverted L-shaped cross-section; and
a non-metallic brush seal assembly fixedly attached to said metallic clearance seal having said inverted L-shaped cross-section; said non-metallic brush seal assembly adapted to said metallic clearance seal to extend through said envelope and terminate in substantially intimate contact with said rotating component having a friction-resistant layer disposed thereon; said friction-resistant layer further comprising a self-lubricating material;
wherein said non-metallic brush seal assembly comprises a plurality of polymer fibers to substantially arrest leakage of a lubricant from said bearing housing to said envelope.

20. The bearing assembly in accordance with claim 19, wherein each of said non-metallic fibers has diameter in the range from about 0.4 mils to about 1 mil.

21. The bearing assembly in accordance with claim 19, wherein each of said non-metallic fibers has stiffness in the range from about 0.4 psi/mil to about 5 psi/mil.

22. A method for retrofitting a non-metallic brush seal in a bearing assembly comprising the steps of:
accessing an existing metallic clearance seal having a plurality of teeth; said metallic clearance seal attached to said bearing housing;
machining at least one tooth of said existing metallic clearance seal to form an envelope having a pre-determined cross-sectional shape adapted to receive a non-metallic brush seal assembly wherein said non-metallic brush seal assembly comprises a plurality of fibers for substantially arresting leakage of a lubricant from said bearing housing to said envelope;
assembling said non-metallic brush seal assembly in said envelope having said pre-determined cross-sectional shape; and
securing said non-metallic brush seal assembly with said metallic clearance seal to prevent circumferential displacement of said non-metallic brush seal assembly relative to said metallic clearance seal.

23. The method in accordance with claim 22, wherein said metallic clearance seal comprises a labyrinth seal.

24. The method in accordance with claim 22, wherein said pre-determined cross-sectional shape comprises at least one of an inverted L-shaped cross section or inverted U-shaped cross-section or F-shaped cross-section or T-shaped cross-section or H-shaped cross-section.

25. The method in accordance with claim 22, wherein said non-metallic fibers are selected from the group consisting of polymer fibers, carbon fibers, graphite fibers, ceramic fibers and combinations thereof.

26. The method in accordance with claim 22, wherein each of said non-metallic fibers has diameter in the range from about 0.4 mils to about 1 mil.

27. The method in accordance with claim 22, wherein each of said non-metallic fibers has stiffness in the range from about 0.4 psi/mil to about 5 psi/mil.
